(19) United States
(12) Patent Application Publication
(10) Pub. No.: US 2015/0268655 A1
(43) Pub. Date: Sep. 24, 2015

(54) METHOD OF AUTHETICATING INTERLOCK FUNCTION OF PLC CONTROL PROGRAM USING SMV

(71) Applicant: UDMTEK CO., LTD., Gyeonggi-do (KR)

(72) Inventors: Chang Mok Park, Seoul (KR); Gi Nam Wang, Gyeonggi-do (KR)

(21) Appl. No.: 14/422,120

(22) PCT Filed: Jul. 31, 2013
(86) PCT No.: PCT/KR2013/006857

§ 371 Date: Feb. 17, 2015

(30) Foreign Application Priority Data
Aug. 23, 2012 (KR) 10-2012-0092484

(51) Int. Cl. G05B 19/05

(52) U.S. Cl. CPC G05B 19/056

(57) ABSTRACT

Provided is a method of verifying an interlock function of a PLC control program which includes transforming the PLC control program into a control intermediate model, simplifying the control intermediate model using information on an output signal list of output signals among a plurality of output signals outputted from the PLC driving system as the PLC control program is driven, transforming the PLC driving system and the simplified control intermediate model into a finite state machine (FSM) form, and verifying in relays of checking whether a situation in which the output signals of the output signal list causing the erroneous situation are turned on (ON) at the same time occurs in the control intermediate model simplified to the FSM form using a symbolic model verifier (SMV) and modifying the PLC control program.

### TECHNICAL FIELD

The present invention relates to a method of verifying interlock function of a PLC control program using a symbolic model verifier (SMV).

### BACKGROUND ART

It is necessary to consider safety in the workplace while designing a PLC control program driven by a PLC driving system controlling an automated production system. When the PLC control program is not properly designed, there may be a malfunction in the automated production system, which may cause great losses such as losses of life and the destruction of expensive facilities.

Generally, particular signals used in the PLC control program, for example, output signals for driving particular facilities are turned on at the same time, thereby causing the malfunction of the automated production system. Accordingly, the malfunction of the automated production system may be prevented by providing a PLC control program absolutely not to allow an erroneous situation defined as a state in which particular signals are turned on at the same time. That is, the PLC control program includes a function of sequentially controlling facilities of the automated production system and an interlock function for preventing an erroneous situation. Since relating to safety, it is necessary to provide full 100% of the interlock function. For example, the interlock function is programmed and included in the PLC control program as shown in FIG. 1 not to allow signals related to operations of particular facilities to be turned on at the same time. Referring to FIG. 1, although conditions of operating facility A is satisfied, since signal B is connected to NOT, when the signal B is turned on (ON), a first circuit always becomes FALSE in such a way that A absolutely cannot be turned on (ON). Similarly, although conditions of operating facility B is satisfied, since the signal A is connected to NOT, when the signal B is turned on (ON), a second circuit always becomes FALSE in such a way that B absolutely cannot be turned on (ON).

However, since the PLC control program includes several thousands of signals and complicated logics, it is not easy for a PLC programmer to check one by one whether the interlock function is perfectly provided to prevent the erroneous situation in which particular signals are turned on (ON) at the same time. To overcome such situations, there is suggested a method of verifying the PLC control program through simulations and test runs. However, when the PLC control program is verified through simulations and test runs, since the number of signal statuses to be inspected increases geometrically, it is impossible to inspect all cases.

### DISCLOSURE OF THE INVENTION

### Technical Problem

The present invention provides a method of verifying an interlock function of a PLC control program, the method capable of verifying whether the interlock function of the PLC control program is perfectly provided to complement the interlock function using a symbolic model verifier (SMV).

### Technical Solution

According to an aspect of the present invention, a method of verifying an interlock function of a PLC control program driven in a PLC driving system controlling an automated production system includes transforming the PLC control program into a control intermediate model in which an output signal is expressed as a parent node and state transformation logics having an effect on state transformation of the output signal are expressed as child nodes, simplifying the control intermediate model using information on an output signal list of output signals among a plurality of output signals outputted from the PLC driving system as the PLC control program is driven, which are turned on (ON) at the same time and cause an erroneous situation in operations of the automated production system, transforming the PLC driving system and the simplified control intermediate model into a finite state machine (FSM) form, and verifying in relays of checking whether a situation in which the output signals of the output signal list causing the erroneous situation are turned on (ON) at the same time occurs in the control intermediate model simplified to the FSM form using a symbolic model verifier (SMV) and modifying the PLC control program to provide the interlock function to prevent the occurrence of the erroneous situation.

In the simplifying the control intermediate model, the control intermediate model may be simplified by removing output signals of an output signal list irrelevant to the erroneous situation and state transformation logics of the corresponding output signals from the control intermediate model.

In the modifying the PLC control program to provide the interlock function to prevent the occurrence of the erroneous situation, a dependent relationship hierarchical structure generating the output signals of the output signal list causing the erroneous situation may be formed and it may be checked step by step whether the situation in which the output signals of the output signal list causing the erroneous situation are turned on (ON) at the same time occurs, on the basis of the dependent relationship hierarchical structure.

### Advantageous Effects

According to one or more embodiments of the present invention, in a method of verifying an interlock function of a PLC control program using a symbolic model verifier (SMV), to prevent an erroneous situation in operations of an automated production system, states of signals causing the erroneous situation and locations of programs among the PLC control program driven in a PLC driving system controlling the automated production system are extracted to be modified or compensated, thereby avoiding inspection of all over the PLC control program when an erroneous situation occurs in operations of the automated production system.

### BRIEF DESCRIPTION OF THE DRAWINGS

FIG. 1 is a view illustrating an interlock function;

FIG. 2 is a flowchart illustrating a method of verifying an interlock function of a PLC control program using a symbolic model verifier (SMV) according to an embodiment of the present invention;

FIG. 3 is a view illustrating an automated production system to which the method of verifying the interlock function of the PLC control program using the SMV is applied according to an embodiment of the present invention;

FIG. 4 is a view illustrating a PLC control program operating in a PLC driving system controlling the automated production system of FIG. 3;

FIG. 5 is a view illustrating that the PLC control program of FIG. 4 is transformed into a control intermediate model;

FIG. 6 is a simplified view of the control intermediate model of FIG. 5 using erroneous situation signal list information;

FIG. 7 is a view illustrating a general operation cycle of a PLC driving system;

FIG. 8 is a view illustrating driving properties of the PLC driving system of FIG. 7 as a finite state machine (FSM);

FIG. 9 is a view illustrating two timer logics shown in FIG. 4 expressed as an FSM;

FIG. 10 is a view illustrating state transformation properties of sensor input signals S1 to S5 shown in FIG. 3 expressed as an FSM;

FIG. 11 is a view illustrating a PLC logic circuit shown in FIG. 4 expressed as an FSM;

FIG. 12 is a view illustrating a situation in which an output signal BELT1 and an output signal UP are turned on (ON) at the same time, as a state of a sensor input signal;

FIG. 13 is a view illustrating a dependent hierarchy beginning with the output signal BELT1 and the output signal UP in order to verify whether the output signal BELT1 and the output signal UP are in an ON state at the same time;

FIG. 14 is a flowchart of verifying and modifying the PLC control program;

FIG. 15 is a view illustrating before and after states of modifying an erroneous situation of the PLC control program; and

FIG. 16 is a view illustrating an example of an FSM used in the SMV.

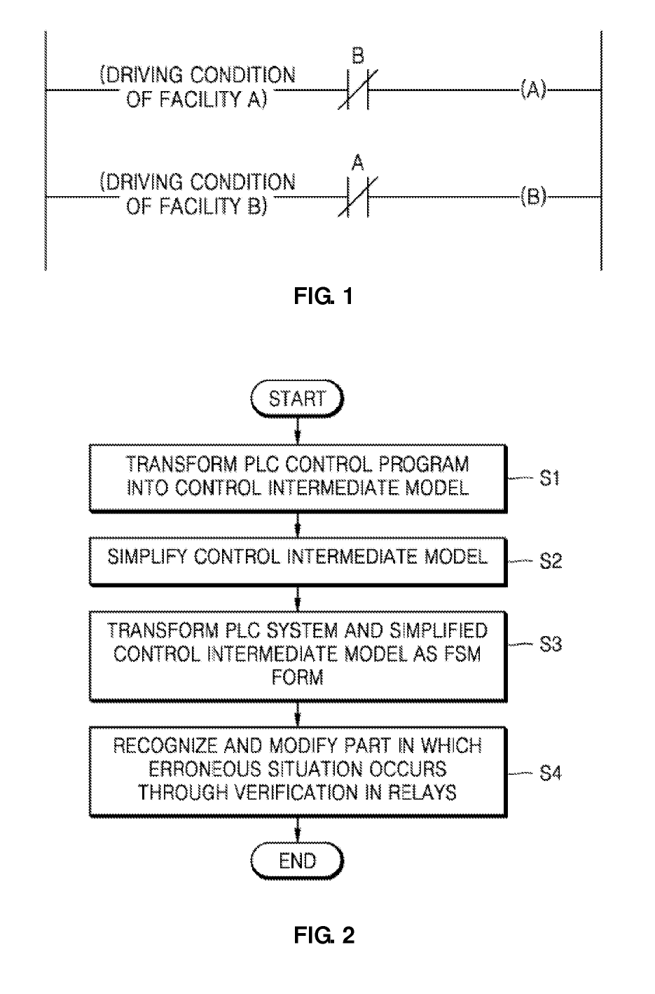

### MODE FOR CARRYING OUT THE INVENTION

Hereinafter, exemplary embodiments of the present invention will be described in detail with reference to the attached drawings.

The embodiments of the present invention are provided to more perfectly explain the present invention to a person of ordinary skill in the art. The following embodiments may be modified into various other forms, and the scope of the present invention is not limited to following embodiments. The embodiments are provided to allow the present disclosure to be more faithful and full and to perfectly transfer the inventive concept to those skilled in the art.

Terms used herein are to describe particular embodiments but will not limit the present invention. As used herein, the singular forms are intended to include the plural forms as well, unless the context clearly indicates otherwise. It will be further understood that the terms “comprises” and/or “comprising” used herein specify the presence of stated shapes, numbers, operations, elements, and/or a group thereof, but do not preclude the presence or addition of one or more other shapes, numbers, operations, elements, and/or groups thereof. As used herein, the term “and/or” includes any and all combinations of one or more of the associated listed items.

It will be understood that although the terms “first”, “second”, etc. may be used herein to describe various components, these components should not be limited by these terms. The terms do not mean a particular order, top and bottom, or superiority but are only used to distinguish one component from another. Accordingly, a first element, area, or portion that will be described below may indicate a second element, area, or portion without deviating from teachings of the present invention.

Hereinafter, the embodiments of the present invention will be described with reference to schematic drawings. In the drawings, for example, according to manufacturing technologies and/or tolerances, illustrated shapes may be modified. Accordingly, the embodiments of the present invention will not be understood to be being limited to certain shapes of illustrated areas but will include modifications in shapes caused while being manufactured.

FIG. 2 is a flowchart illustrating a method of verifying an interlock function of a PLC control program using a symbolic model verifier (SMV) according to an embodiment of the present invention.

Referring to FIG. 2, the method of verifying the interlock function of the PLC control program using the SMV is a method of verifying an interlock function of a PLC control program driven in a PLC driving system controlling an automated production system using an SMV.

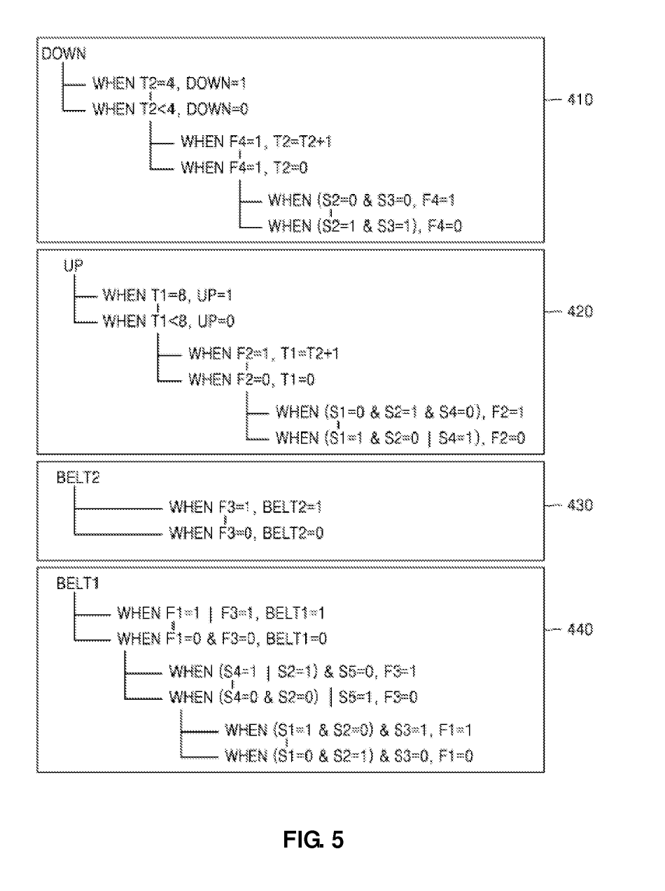

Referring to FIG. 2, the method of verifying the interlock function of the PLC control program may be performed in an order of transforming the PLC control program into a control intermediate model expressing an output signal and state transformation logics as a parent node and child nodes, respectively (S1), simplifying the control intermediate model using information of a list of output signals turned on (ON) at the same time and generating an erroneous situation of operations of the automated production system among a plurality of output signals outputted from the PLC driving system as the PLC control program is driven (S2), transforming the PLC driving system and the simplified control intermediate model into a finite state machine (FSM) form (S3), and modifying the PLC control program to provide an interlock function to prevent the erroneous situation by verifying in relays of checking whether a state in which the output signals of the list are turned on (ON) at the same time, which generates the erroneous situation in the control intermediate model transformed into the FSM form, using the SMV (S4). Herein, the simplification of the control intermediate model may be performed by removing a list of output signals irrelevant to the erroneous situation and state transformation logics of the corresponding output signals from the control intermediate model. Also, state transformation logic has an effect on the state transformation of an output signal. For example, referring to FIG. 5, state transformation logic having an effect on an output signal BELT1 may include logical formulas of sensor input signals S1, S2, and S3 having an effect on a state of an internal signal F1, state transformation of an internal signal F3, or state transformation of the internal signal F1. Also, state transformation logic having an effect on an output signal UP may include logical formulas of sensor input signals S1, S2, and S4 having an effect on state transformation of a timer T1, state transformation of an internal signal F2 having an effect on the state transformation of the timer T1, and state transformation of the internal signal F2.

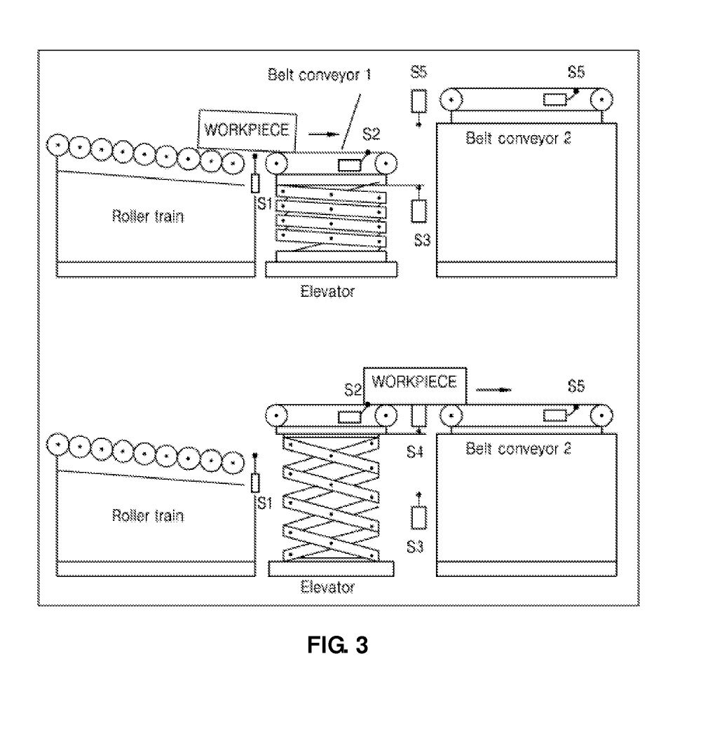

FIG. 3 is a view illustrating an automated production system to which the method of verifying the interlock function of the PLC control program using the SMV is applied according to an embodiment of the present invention.

Referring to FIG. 3, the automated production system repetitively performs operations in a following order of drive 1→drive 2→drive 3→drive 4→drive 5. That is, the automated production system may be controlled by a PLC driving system driving a PLC control program programmed to have a drive procedure described as follows.

Drive 1: When a workpiece approaching a roller train is sensed by a sensor S1, a belt conveyer 1 is driven.

Drive 2: When the workpiece arrives at a right end of the belt conveyer 1 and then is sensed by a sensor S2, an elevator ascends after 8 seconds.

Drive 3: When the elevator ascends to the top and is sensed by a sensor S4, the elevator stops ascending.

Drive 4: When the elevator stops ascending, the belt conveyer 1 and a belt conveyer 2 are driven at the same time to transfer the workpiece to a right end of the belt conveyer 2.

Drive 5: When the workpiece disappears and there is no object-sensing signal from the sensor S2, the elevator descends after 4 seconds.

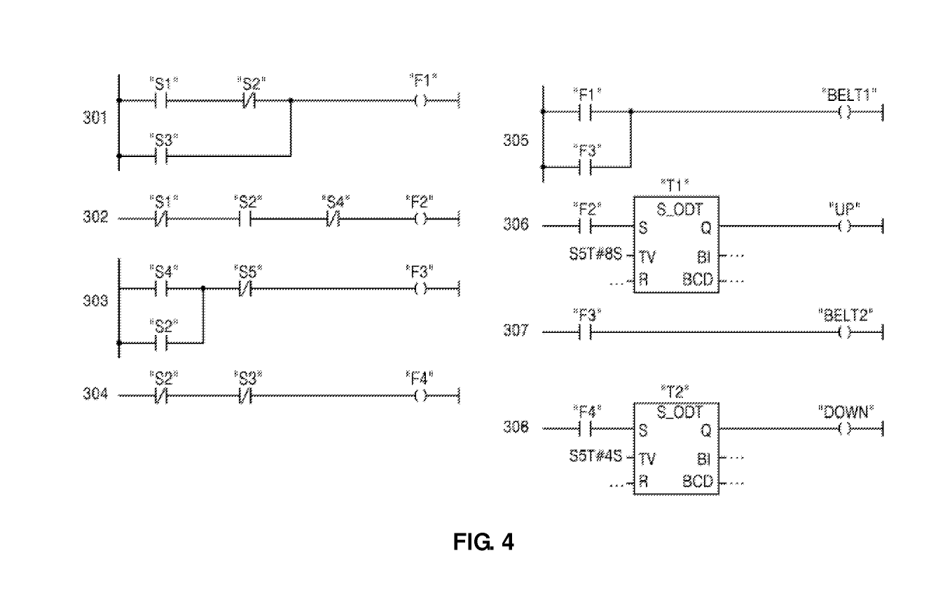

As described above, the PLC control program operating in the PLC driving system controlling the automated production system of FIG. 3 is shown in FIG. 4.

Referring to FIG. 4, the PLC control program includes sensor input signals S1, S2, S3, S4, and S5 indicating sensor states, internal signals F1, F2, F3, and F4 indicating a state of the automated production system, and output signals UP, DOWN, BELT1, and BELT2 for driving facilities of the automated production system.

The internal signal F1 indicates a state of the automated production system, in which the workpiece is transferred from the roller train to the right end of the belt conveyer 1 and is turned on (ON) when a condition of [(S1=ON AND S2=OFF) OR S3=ON] is satisfied (301).

The internal signal F2 indicates a state in which the workpiece is lifted up using the elevator and is turned on (ON) when a condition of [(S1=OFF AND S2=ON AND S4=OFF] is satisfied (302).

The internal signal F3 indicates a state in which the two belt conveyers 1 and 2 are driven at the same time to transfer the workpiece to the right end of the belt conveyer 2 and is turned on (ON) when a condition of [(S4=ON OR S2=1) AND S5=OFF] is satisfied (303).

The internal signal F4 indicates a state in which the elevator descends and is turned on (ON) when a condition of [S2=OFF AND S3=OFF] is satisfied (304).

When one of the internal signals F1 and F3 defined as described above is turned on (ON), the output signal BELT1 for driving the belt conveyer 1 is turned on (ON) (305).

When the internal signal F2 is turned on (ON), and after 8 seconds, the output signal UP to allow the elevator to ascend is turned on (ON) (306).

When the internal signal F3 is turned on (ON), the output signal BELT2 for driving the belt conveyer 2 is turned on (ON) (307).

When the internal signal F4 is turned on (ON), and after 4 seconds, the output signal DOWN to allow the elevator to descend is turned on (ON) (308).

When the output signals UP and BELT1 are turned on (ON) at the same time, since the workpiece hits the base of the conveyer belt 2, it may be defined as an erroneous situation. Accordingly, an erroneous situation that may occur due to the PLC control program driven in the PLC driving system controlling the automated production system shown in FIG. 3 is a state in which the output signals UP and BELT1 are turned on (ON) at the same time and may be indicated as UP=ON AND BELT1=ON.

FIG. 5 is a view illustrating that the PLC control program of FIG. 4 is transformed into a control intermediate model.

The control intermediate model is a model in which an output signal is expressed as a parent node and state transformation logics are expressed as child nodes.

As a result, the PLC control program is expressed as a set of intermediate models. Since variables present in the state transformation logics may include subordinate state transformation logics, when the entire structures are connected, the control intermediate model has a tree shape having a hierarchical structure. As shown in FIG. 5, the control intermediate model having the tree structure is a structure from which a subordinate relationship of variables may be extracted.

The output signal DOWN is turned on (ON) when a timer T2 comes to 4 seconds, the timer T2 is driven when the internal signal F4 is turned on (ON), and the internal signal F4 is turned on (ON) or turned off (OFF) by logical formulas of the sensor input signals S2 and S3 (410).

The output signal UP is turned on (ON) when the timer T1 comes to 8 seconds, the timer T1 is driven when the internal signal F2 is turned on (ON), and the internal signal F2 is turned on (ON) or turned off (OFF) by logical formulas of the sensor input signals S1, S2 and S4 (420).

The output signal BELT2 is turned on (ON) when the internal signal F3 is turned on (ON), and the internal signal F3 is turned on (ON) or turned off (OFF) by logical formulas of the sensor input signals S2, S4 and S5 (430).

The output signal BELT1 is turned on (ON) when one of the internal signals F1 and F3 is turned on (ON), the internal signal F1 is turned on (ON) or turned off (OFF) by logical formulas of the sensor input signals S1, S2 and S3, and the internal signal F3 is turned on (ON) or turned off (OFF) by logical formulas of the sensor input signals S2, S4 and S5 (440).

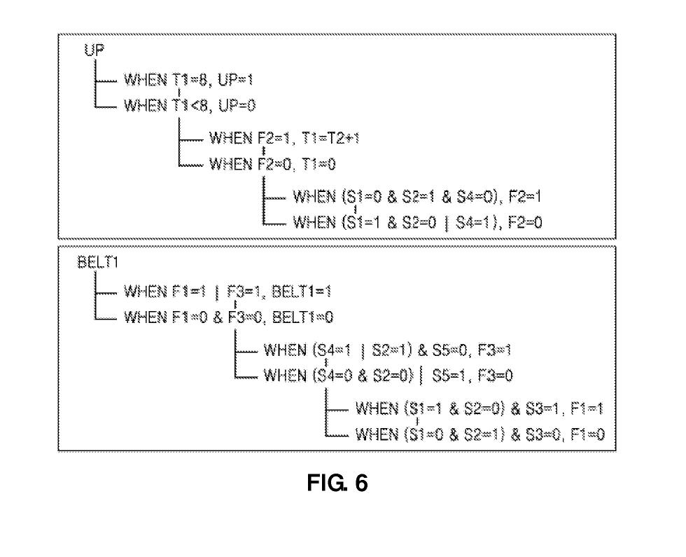

FIG. 6 is a simplified view of the control intermediate model shown in FIG. 5.

Referring to FIG. 6, since the verification of the interlock function of the PLC control program according to an embodiment of the present invention is to inspect whether an erroneous situation in which two or more output signals are turned on (ON) at the same time when the PLC control program is driven in the PLC driving system and to modify the PLC control program not to allow the erroneous situation to occur, the verification of the interlock function of the PLC control program is performed while the control intermediate model shown in FIG. 5 is being simplified to analyze only variables causing erroneous situations. Accordingly, it is possible to reduce a space to be detected, thereby reducing a verification time.

In FIG. 5, the output signals BELT1 and UP are turned on (ON) at the same time, which causes an erroneous situation. However, since the output signals DOWN and BELT2 do not have an effect thereon, subordinate trees of the output signals DOWN and BELT2 are excluded from the control intermediate model shown in FIG. 5 and the control intermediate model is simplified to have subordinate relationships connected to the output signals BELT1 and UP as shown in FIG. 6. Actually, sine the PLC control program driven in the PLC driving system controlling the automated production system connected with a large number of signals as a subordinate relationship, the simplification may effectively simplify a verification system.

To verify the interlock function of the PLC control program using the SMV that is a verifier tool used herein, state transformation properties of the PLC driving system, that is, state transformation of output signals are to be expressed as an FSM. Since the SMV uses a method of verifying whether a system expressed as an FSM form is out of the specification and detects the whole state space, the SMV performs verification about perfect. To verify the interlock function of the PLC control program using the SMV, it is necessary to transform the PLC driving system, in which the PLC control program is driven, into the SMV form.

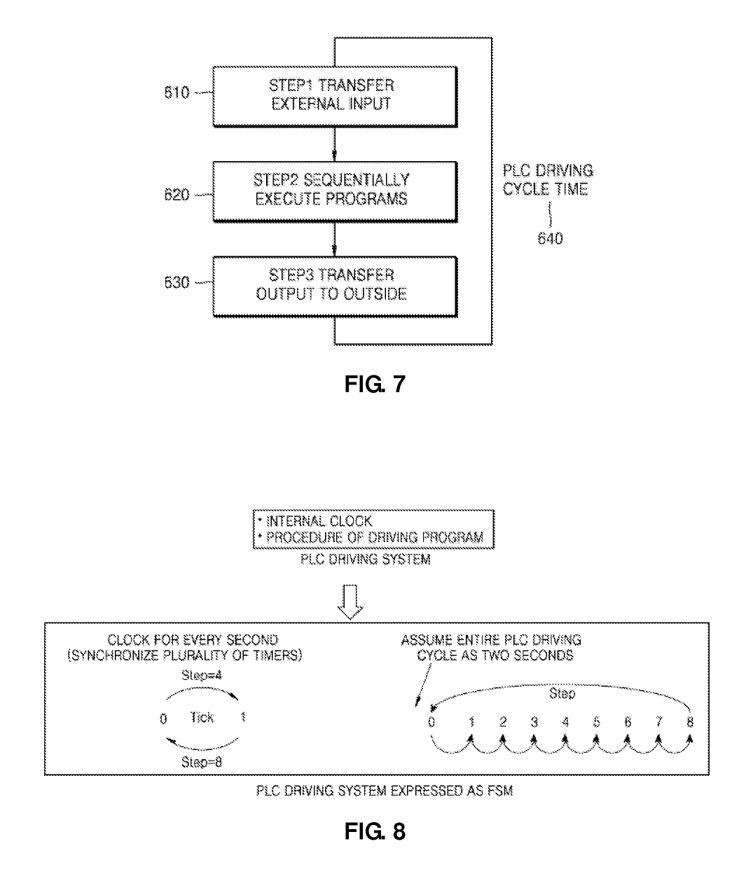

Before transforming the PLC driving system into the SMV form, an operation cycle of the PLC driving system will be described with reference to FIG. 7. Referring to FIG. 7, the PLC driving system repetitively performs operations of the cycle as shown in FIG. 7. In step 1, an external input signal is transferred to an internal input memory of the PLC control program (610). According thereto, there will be no change in the internal input memory other steps except step 1. In step 2, the PLC control program is sequentially executed (620). Herein, since a result varies with an execution sequence, it is necessary to keep a code sequence of the PLC control program. A result of sequential execution of the PLC control program is stored in the internal input memory. In step 3, an output memory is transferred to every output signal (630). Herein, in step 3, it is checked whether an erroneous situation occurs while the PLC control program is being executed randomly changing input. Since it takes too much time, there is provided the method of verifying the interlock function of the PLC control program using the SMV according to an embodiment of the present invention.

On the other hand, from step 1 to the last step, it is designed to drive the PLC driving system at certain points in time (640).

The FSM form used in the SMV describes a particular system using several state machines having a state and transfer properties.

FIG. 8 is a view illustrating driving properties of the PLC driving system of FIG. 7 as an FSM form.

Referring to FIG. 8, a step model is to express sequential driving of step 1→step 2 of sequential execution of program→step 3, is to allow all logics to be executed in a determined sequence, is to prevent a change in an input value while a program is being executed, and is to designate a check point in time with respect to output. In the model, input values may be changed to a random state when a state of the step is 0 and it is the check point in time with respect to output when the state of the step is 8. Other states of the step indicate points in time of executing logics. Through the step model, synchronization of the PLC driving system expressed as the FSM is performed.

Also, a tick model is a model expressing time through assumption with respect to the PLC driving cycle and allows synchronization among a plurality of timer variables present in the PLC driving system.

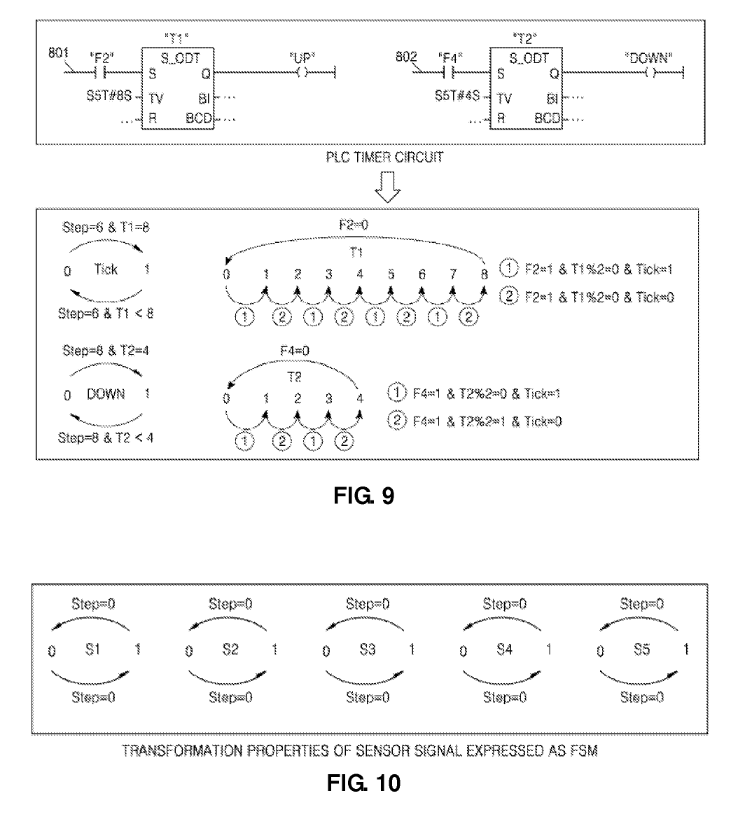

FIG. 9 is a view illustrating two timer logics shown in FIG. 4 expressed as FSMs.

Referring to FIG. 9, synchronization between timer variables is expressed through a tick variable defined in FIG. 8.

A driving type of logic having an actual timer is as follows.

When the internal signal F2 is turned on (ON), the timer T1 operates, and after 8 seconds, the output signal UP is turned on (ON) (801).

When the internal signal F4 is turned on (ON), the timer T2 operates, and after 4 seconds, the output signal DOWN is turned on (ON) (802).

There are a model UP, a model DOWN, a model T1, and a model T2, which express the driving type as FSMs. The timer T1 is designed to allow a state to be transformed in every second and to be synchronized with a tick state to allow state transformation to occur only when the internal signal F2 is turned on (ON). Also, the timer T2 is designed to allow a state to be transformed in every second and to be synchronized with a tick state to allow state transformation to occur only when the internal signal F4 is turned on (ON). Herein, the output signal UP is expressed to be transferred from 0 to 1 when the timer T1 becomes 8th second and a PLC logic sequence number is 6 and the output signal DOWN, similarly, is expressed to be transferred from 0 to 1 when the timer T2 becomes 4th second and a PLC logic sequence number is 8.

FIG. 10 illustrates that with respect to models of the sensor input signals S1 to S5 shown in FIG. 4, input signal states may be transformed into 0 or 1 only when the step is 0.

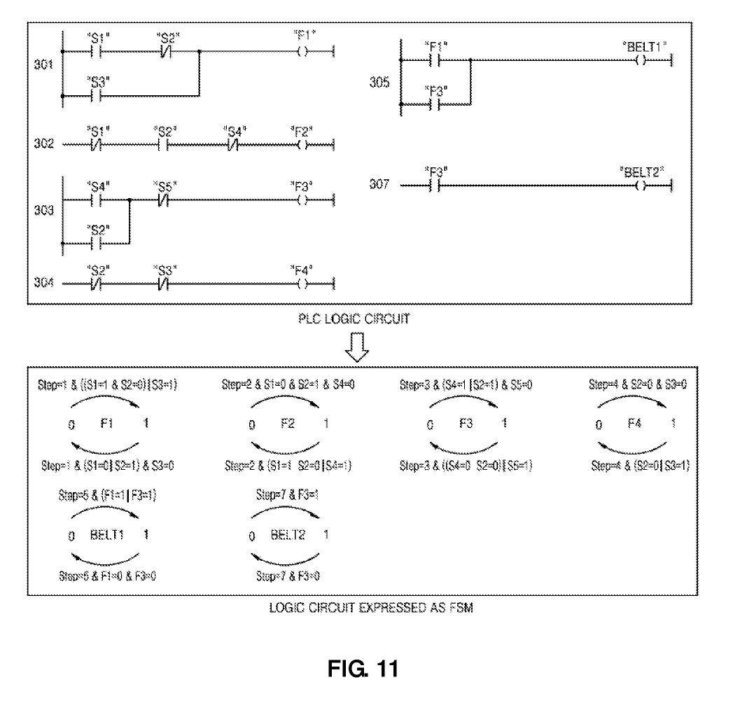

FIG. 11 is a view illustrating a PLC logic circuit shown in FIG. 4 expressed as an FSM.

Referring to FIG. 11, models of the internal signals F1, F2, and F3 and the output signals BELT1 and BELT2 express driving properties in which signal values are changed by respective logic circuits.

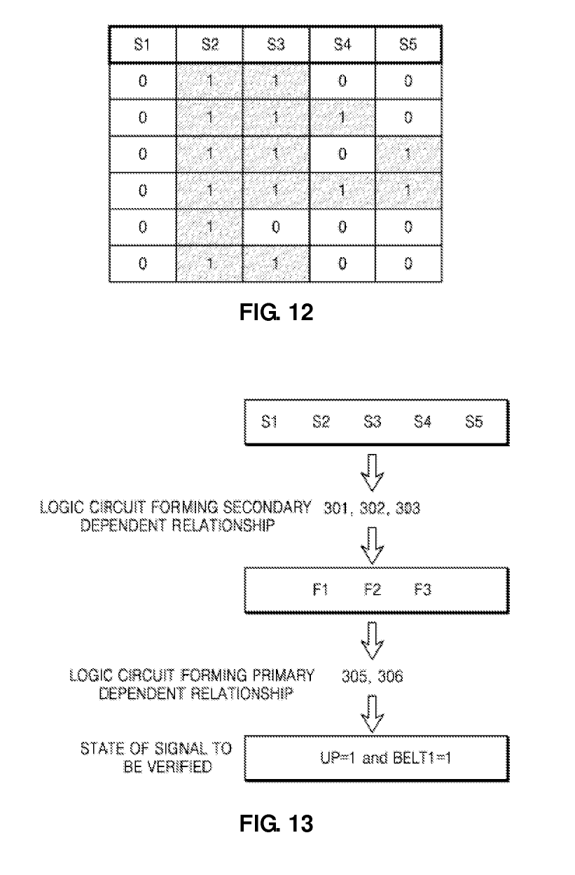

In the PLC control program shown in FIG. 4, there are five cases of a situation in which the output signals BELT1 and UP are turned on (ON) at the same time, which is shown in FIG. 12.

Referring to FIG. 12, the situation in which the output signals BELT1 and UP are turned on (ON) at the same time may be expressed as a state of a sensor input signal.

It is impossible to detect all of the cases using an actual SMV tool in a large PLC control program. Although all the cases are made, it is very difficult to modify the PLC control program using the cases. That is, it is very difficult to modify the PLC control program not to allow the output signals BELT1 and UP are turned on (ON) at the same time when the five situations shown in FIG. 12 occur. This is, it is impossible to know which part of the PLC control program is to be modified and it is difficult to know information with respect to most effective modification because there may be several ways of modification. Such difficulties become greater in a PLC control program of a larger automated production system.

Accordingly, the method of verifying the interlock function of the PLC control program using the SMV according to an embodiment of the present invention includes executing verification in relays of finding states of signals to allow output signals to be turned on (ON) at the same time using the SMV and modifying the PLC control program not to allow an erroneous situation to occur using the states of signals found as a result of the verification in relays and a logical circuit number of a dependent hierarchical structure shown in FIG. 13.

The PLC control program is written to complexly mix various conditions and sequences due to properties of design. Due to the properties, to check whether a particular state occurs, when a tree structure using a mutual dependent relationship of signal is formed and verification in relays is performed on the basis thereof, there is obtained an effect of dividing the entire problem into several unit problems to verify and it is possible to be free from state explosion due to a too large detection space to be detected.

FIG. 13 is a view illustrating a dependent hierarchy beginning with the output signals BELT1 and UP in order to verify whether the output signals BELT1 and UP are turned on (ON) at the same time.

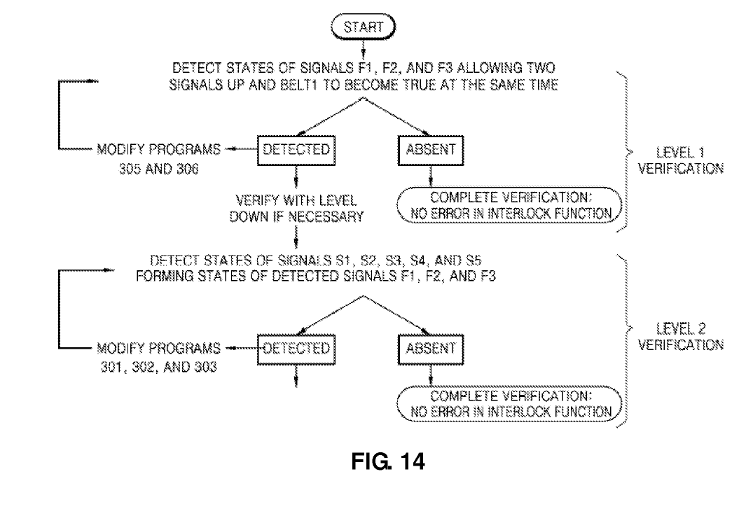

Referring to FIG. 13, logics related to the output signals BELT1 and UP are 305 and 306 and internal signals related thereto are F1, F2, and F3. Also, logics related to the internal signals F1, F2, and F3 are 301,302, and 303 and the sensor input signals related thereto are S1, S2, S3, S4, and S5. The verification of the PLC control program having the structure may be performed by verifying a state in which the output signals BELT1 and UP are turned on (ON) at the same time. Also, it is possible to simplify the verification and modification of the PLC control program by using algorithm shown in FIG. 14.

Referring to FIG. 14, a verification procedure is same as follows.

A verification method of level 1 of FIG. 14 indicates a verification method only using a primary dependent relationship shown in FIG. 13.

1. A combination of states of the internal signals F1, F2, and F3 causing an erroneous situation (UP=1 & BELT=1) is detected using the SMV.

2. The erroneous situation occurs when [F1=1, F2=1, F3=0].

3. A programmer, etc. modifies programs 305 and 306 and allows the erroneous situation not to occur when [F1=1, F2=1, F3=0].

4. The procedure described above is repetitively performed until the combination of states of the internal signals F1, F2, and F3, which causes the erroneous situation, does not occur.

Since the internal signals F1, F2, and F3 determine the states of the output signals UP and BELT1, it is efficient and easily managed to allow the PLC control programs 305 and 306 to prevent the erroneous situation. The PLC control program designed by an actual programmer generally has such form.

However, when it is impossible to prevent the erroneous situation due to modification of programs 305 and 306 or in order to verify detecting a part to allow preventing the erroneous situation to be easy, it is possible to verify by leveling down a dependent relationship using a following verification procedure.

That is, a verification method of level 2 of FIG. 14 indicates a verification method only using a secondary dependent relationship shown in FIG. 13.

11. The combination of states of the sensor input signals S1, S2, S3, S4, and S5 causing the internal signal state [F1=1, F2=1, F3=0] detected in the verification of level 1 is detected using the SMV.

12.When [S1=0, S2=1, S3=1], the state of [F1=1, F2=1, F3=0] occurs.

13.When the programmer, etc. modifies programs 301, 302,303 not to allow the state of [F1=1, F2=1, F3=0] to occur when the sensor input signal is [S1=0, S2=1, S3=1].

14. The procedure described above is repetitively performed until the states of the sensor input signals S1, S2, S3, S4 and S5 causing the state of [F1=1, F2=1, F3=0] is not detected.

The SMV is a formal verification method on the basis of state detection. When a system expressed as an FSM and properties are given, the SMV inspects the whole state space to check whether the given system satisfies properties to be verified by using model checking algorithm. When the properties are not satisfied, a counter example is given. That is, the counter example indicates a state of the system not satisfying the properties.

The FSM form used in the SMV may be in brief into four types as shown in Table 1.

TABLE 1

| Form | Description | Example |
|---|---|---|
| Variable | Set Variable of System | VAR BELT1: Boolean |
| Declaration | | |
| Initial Value | Assign Initial Value of | Assign |
| of Variable | Variable | init(BELT1):=FALSE |
| Variable State | Assign How State of | Assign next(BELT1):= |
| Transformation | Variable transforms | caseF1 \| F3 : TRUE ; |
| | | ! (F1 \| F3) : FALSE ; |
| System | Check Which Formula Is | INVARSPEC!(BELT1 & |
| Properties | Always FALSE (e.g.: | UP) |
| | BELT1 & UP Are Always | |
| | FALSE) | |

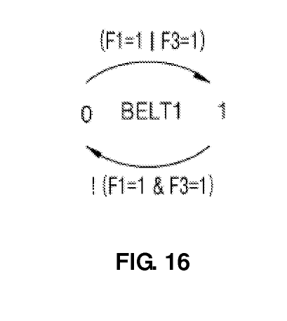

FIG. 16 illustrates an FSM form used in system properties in Table 1.

When the PLC driving system, the PLC control program, and an erroneous situation to be verified are system-specified using input language of an SMV and an SMV verification program is driven, the SMV recognizes and notifies states of signals in the erroneous situation. When the erroneous situation does not occur, the SMV notifies that an error does not occur.

In the above, when the SMV is used to check the erroneous situation, that is, a situation in which BELT1 & UP becomes TRUE, that is, are turned on (ON) at the same time, the SMV verification program is driven while five sensor input signals, four internal signals, four output signals, eight variable state transformation logics are being all expressed as FSM forms, thereby detecting a relatively larger state space, which causes an increase in verification time. Also, the SMV only provides the states of the sensor input signals causing the erroneous situation but it is impossible to obtain information for modification of the PLC control program.

Accordingly, when the method of simplifying the control intermediate model described above is used, since five sensor input signals, three internal signals, two output signals, and five variable state transformation logics are primarily used, a state space for the SMV verification becomes reduced.

Also, when the verification in relays described above is used, since only three internal signals, two output signals, and two variable state transformation logics are used in the verification of level 1, a state space for the SMV verification becomes reduced. Since a location of the PLC control program to be modified may be known using a verification result and PLC control program hierarchy information, it is possible to perform efficient modification.

Similarly, when only the verification of level 2 among the verification in relays described above is used, since only five input signals, three internal signals, and three variable state transformation logics are used, a state space for the SMV verification becomes reduced. Since a location of the PLC control program to be modified may be known using a verification result and PLC control program hierarchy information, it is possible to perform efficient modification.

Modification of the PLC control program indicates that a programmer of the PLC control program checks the location of the PLC control program, that is, the number of the program described above and modifies when there is a part wrongly written. When there is a part that is properly written but is not considered by the programmer of the PLC control program, additional logic may be inserted.

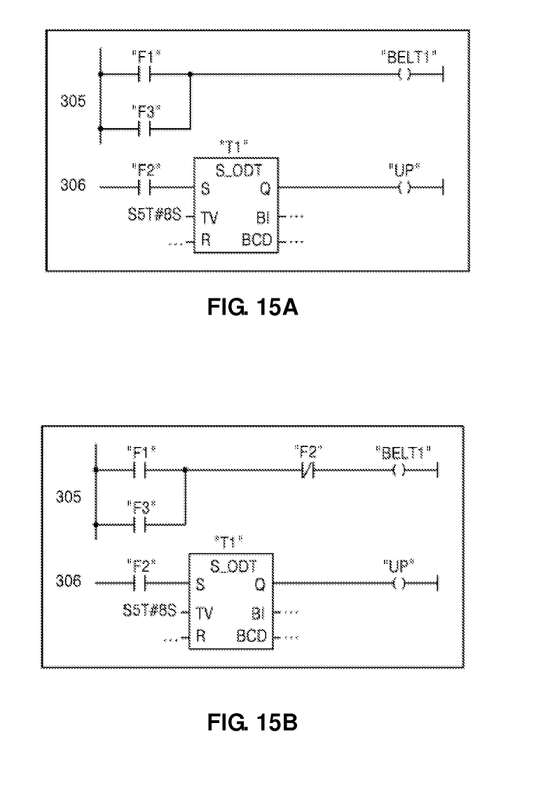

For example, in the procedure described above, the programmer, etc. modifies the programs 305 and 306 not to allow an erroneous situation to occur when [F1=1, F2=1, F3=0], in which the programs 305 and 306 are same as shown in FIG. 15(a).

Referring to FIG. 15(a), since the output signals BELT1 and UP are turned on (ON) at the same time when the internal signals are [F1=1, F2=1, F3=0], the programmer of the PLC control program may properly modify the PLC control program. FIG. 15(b) illustrates a result of modification described above. However, different from FIG. 15(b), programs 301,302, and 303 may be modified using the verification of level 2 not to allow states of the internal signals [F1=1, F2=1, F3=0] to occur.

As described above, exemplary embodiments of the present invention have been described. While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, the disclosed embodiments will be considered in the view of description not in the view of limitation. Accordingly, the scope of the present invention will not be limited to the embodiments described above but will be understood to include the contents disclosed in the claims and various equivalents thereof.

### INDUSTRIAL APPLICABILITY

The present invention may be applied to automated production systems.

What is claimed:

1. A method of verifying an interlock function of a PLC control program driven in a PLC driving system controlling an automated production system, the method comprising:
transforming the PLC control program into a control intermediate model in which an output signal is expressed as a parent node and state transformation logics having an effect on state transformation of the output signal are expressed as child nodes;
simplifying the control intermediate model using information on an output signal list of output signals among a plurality of output signals outputted from the PLC driving system as the PLC control program is driven, which are turned on (ON) at the same time and cause an erroneous situation in operations of the automated production system;
transforming the PLC driving system and the simplified control intermediate model into a finite state machine (FSM) form; and
verifying in relays of checking whether a situation in which the output signals of the output signal list causing the erroneous situation are turned on (ON) at the same time occurs in the control intermediate model simplified to the FSM form using a symbolic model verifier (SMV) and modifying the PLC control program to provide the interlock function to prevent the occurrence of the erroneous situation.

2. The method of claim 1, wherein in the simplifying the control intermediate model, the control intermediate model is simplified by removing output signals of an output signal list irrelevant to the erroneous situation and state transformation logics of the corresponding output signals from the control intermediate model.

3. The method of claim 1, wherein in the modifying the PLC control program to provide the interlock function to prevent the occurrence of the erroneous situation, a dependent relationship hierarchical structure generating the output signals of the output signal list causing the erroneous situation is formed and it is checked step by step whether the situation in which the output signals of the output signal list causing the erroneous situation are turned on (ON) at the same time occurs, on the basis of the dependent relationship hierarchical structure.
